(19) United States
(12) Patent Application Publication
(10) Pub. No.: US 2018/0183148 A1
(43) Pub. Date: Jun. 28, 2018

(54) COMPACT QUASI-ISOTROPIC SHORTED PATCH ANTENNA AND METHOD OF FABRICATING THE SAME

(71) Applicant: South China University of Technology, Guangzhou (CN)

(72) Inventors: Yong-Mei Pan, Guangzhou (CN); Shaoyong Zheng, Guangzhou (CN)

(21) Appl. No.: 15/598,309

(22) Filed: May 17, 2017

(30) Foreign Application Priority Data
Dec. 22, 2016 (CN) 201611195910.5

(51) Int. Cl. H01Q 9/04; H01Q 13/08; H01Q 1/48

(52) U.S. Cl. CPC H01Q 9/0421; H01Q 1/48; H01Q 13/08

(57) ABSTRACT

A compact quasi-isotropic shorted patch antenna and method of fabricating the same are disclosed. The patch antenna uses a small ground plane which has same dimensions with the radiating patch, therefore the radiation caused by the currents on the radiating patch is cancelled out by that comes from the opposite currents on the ground plane. Quasi-TEM mode is excited in the radiating patch cavity, generating surface magnetic currents on the open-ended slot and electric currents on the shorted side-wall. The corresponding currents are found not only perpendicular but also quadrature with each other, and therefore the patch antenna can provide a quasi-isotropic radiation pattern without involving complex feeding circuit.

### CROSS REFERENCE TO RELATED APPLICATIONS

The present application claims the benefit of Chinese Patent Application No. 201611195910.5 filed on Dec. 22, 2016. All the above are hereby incorporated by reference.

### TECHNICAL FIELD

The present disclosure relates generally to a patch antenna, and more particularly, to a compact quasi-isotropic shorted patch antenna and method of fabricating the same.

### BACKGROUND

Due to the uniform and full coverage of signal, isotropic antennas are very popular in wireless access points (APs) and radio frequency identification (RFID) systems. Straightforwardly, isotropic radiation can be achieved by arraying a circle of unidirectional antenna elements, but this method generally involves bulky antenna configurations and complex feeding networks. Isotropic radiation can also be obtained by properly combining an electric dipole and an orthogonal magnetic dipole. The former and latter provide omnidirectional radiation patterns in the H- and E- planes respectively, a three dimensional (3D) quasi-isotropic pattern can therefore be realized when the two dipoles are excited by signals with quadrature phases and appropriate amplitudes (ηI₃=±jIₘ). The complementary concept was first used to design a quasi-isotropic antenna by combining a monopole and two slots. However, since a large ground plane was used in the structure, quasi-isotropic coverage was obtained only in upper half-space. Later, a printed dipole and a pair of 1.4-turn printed loops (magnetic dipole) were combined to provide a full spatial coverage, with gain difference given by 3.8 dB over the entire spherical radiating surface. The radiation efficiency, however, is only 30.4% due to severe ohmic loss. Four sequential rotated L-shaped monopoles can also provide a gain difference less than 6 dB within full space, but four way signals with equal amplitudes and quadrature phases of 0°, 90°, 180° and 270° are needed for exciting the monopoles and therefore a sequential-phase feeding network has to be included in the design.

Therefore, a heretofore unaddressed need exists in the art to address the aforementioned deficiencies and inadequacies.

### SUMMARY

In one aspect, the present invention relates to a quasi-isotropic patch antenna consisting of a radiating patch, a ground plane, and a metallic sidewall which connects the former two to form an open-ended slot. A feeding device is used to feed the quasi-isotropic patch antenna and excite its fundamental TEM mode, whose magnetic fields generate surface electric currents on the metallic sidewall and electric fields generate surface magnetic currents on the opposite open-ended slot.

In one embodiment, the radiating patch is a quarter-wave radiating patch. In the present embodiment, the radiating patch has a rectangular, circular, or triangular shape. In the present embodiment, the radiating patch and the ground plane have the same dimensions.

In one embodiment, the feeding device is a coaxial cable comprising an inner conductor soldered to the radiating patch at a displacement from the metallic sidewall and an outer conductor connected to the ground plane.

In one embodiment, the inner conductor has a cylindrical, a conical, or a rectangular shape.

In one embodiment, the coaxial cable is bent to be parallel with the quasi-isotropic patch antenna.

In one embodiment, a dielectric substrate is used between the radiating patch and the ground plane. In another embodiment, an air substrate is used to enhance impedance bandwidth of the quasi-isotropic patch antenna.

In one embodiment, the quasi-isotropic patch antenna is fabricated from a thin copper brick. In another embodiment, the quasi-isotropic patch antenna is fabricated from a printed circuit board.

In one embodiment, the metallic sidewall is realized by a metallic sheet or shoring vias.

In another aspect, the present invention relates a quasi-isotropic patch antenna comprising a quarter-wave rectangular radiating patch, a ground plane, and a metallic sidewall which connects the former two to form an open-ended slot, and a feeding device used to feed the quasi-isotropic patch antenna and excite its fundamental TEM mode, whose magnetic fields generate surface electric currents on the metallic sidewall and electric fields generate surface magnetic currents on the opposite open-ended slot.

In one embodiment, the quarter-wave rectangular radiating patch and the ground plane have same dimensions, wherein the feeding device is a coaxial cable comprising an inner conductor soldered to the quarter-wave rectangular radiating patch at a displacement from the metallic sidewall and an outer conductor connected to the ground plane. In the present embodiment, the coaxial cable is bent to be parallel with the quasi-isotropic patch antenna. In the present embodiment, a dielectric substrate is used between the quarter-wave rectangular radiating patch and the ground plane. In the present embodiment, the metallic sidewall is realized by a metallic sheet or shoring vias. In another embodiment, an air substrate is used to enhance impedance bandwidth of the quasi-isotropic patch antenna.

In a further aspect, the present invention relates a method of fabricating a quasi-isotropic patch antenna comprising the following steps:

S1, setting a radiating patch and a ground plane as large as the radiating patch;

S2, connecting the radiating patch and the ground plane by a metallic side-wall;

S3, inserting a feeding device near the metallic side-wall to feed the patch antenna,

S4, tuning dimensions of the radiating patch to optimize the isotropic pattern, and adjusting feeding position of the feeding device for good match,

S5, repeating step S4 until satisfying performance is achieved. In one embodiment, step S3 further comprises the following steps: S31, soldering inner conductor of the feeding device to the radiating patch at a displacement from the metallic sidewall;

S32, connecting outer conductor of the feeding device to the ground plane; and

S33, bending the feeding device to be parallel with the patch antenna.

In one embodiment, the method of fabricating a patch antenna further comprises the following step:

S6, arranging an air substrate between the radiating patch and the ground plane to enhance impedance bandwidth of the patch antenna.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 shows a configuration diagram of a quasi-isotropic patch antenna according to one embodiment of the present application.

FIG. 2 shows surface current distributions on the patch antenna according to FIG. 1.

FIG. 3 shows calculated 3D radiation pattern of the patch antenna.

FIG. 4 shows simulated and measured reflection coefficients of the patch antenna.

FIG. 5A shows calculated, simulated, and measured field patterns of the patch antenna in the elevation plane.

FIG. 5B shows calculated, simulated, and measured field patterns of the patch antenna in the azimuthal plane.

FIG. 6A shows simulated 3D radiation patterns of the shorted patch antenna at 2.44 GHz.

FIG. 6B shows measured 3D radiation patterns of the shorted patch antenna at 2.44 GHz.

FIG. 7 shows realized gains of the patch antenna at θ=0°.

FIG. 8A shows simulated reflection coefficient of the isotropic patch antenna for different patch lengths.

FIG. 8B shows simulated reflection coefficient of the isotropic patch antenna for different patch widths.

FIG. 8C shows simulated reflection coefficient of the isotropic patch antenna for different patch heights.

FIG. 9 shows simulated reflection coefficients of different patch antennas operating at 2.4-GHz.

FIG. 10A shows 3D radiation patterns of patch Antenna I given in Table II operating at 2.4-GHz.

FIG. 10B shows 3D radiation patterns of patch Antenna III given in Table II operating at 2.4-GHz.

FIG. 11 shows simulated reflection coefficient of the patch antenna for different positions of the feeding device.

FIG. 12 shows simulated reflection coefficient of the patch antenna for different side-lengths of the ground plane.

### DETAILED DESCRIPTION OF THE PREFERRED EMBODIMENT

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. The use of examples anywhere in this specification, including examples of any terms discussed herein, is illustrative only, and in no way limits the scope and meaning of the invention or of any exemplified term. Likewise, the invention is not limited to various embodiments given in this specification.

As used herein, “around”, “about” or “approximate” shall generally mean within10 percent, preferably within 5 percent, and more preferably within 3 percent of a given value or range. Numerical quantities given herein are approximate, meaning that the term “around”, “about” or “approximate” can be inferred if not expressly stated.

As used herein, the terms “comprising,” “including,” “having,” “containing,” “involving,” and the like are to be understood to be open-ended, i.e., to mean including but not limited to.

The description will be made as to the embodiments of the present invention in conjunction with the accompanying drawings in FIGS. 1-12. In accordance with the purposes of this disclosure, as embodied and broadly described herein, this disclosure, in one aspect, relates to a quasi-isotropic patch antenna.

Referring now to FIG. 1, a quasi-isotropic patch antenna is shown according to one embodiment of the present invention. The patch antenna consists of a radiating patch 10, a ground plane 20, and a metallic side-wall 40 that connects the former two and forms an open-ended slot 60 between the radiating patch 10 and the ground plane 20. The radiating patch 10 and the ground plane 20 can have same dimensions, with their length and width given by a and b, respectively. In the present embodiment, the radiating patch 10and the ground plane 20 are square, and a=b=27 mm. In other embodiment, the radiating patch 10 and the ground plane 20 can be designed in other shapes, dimensions and type. For example, the radiating patch 10 can have a rectangular, circular, or triangular shape as known by one skilled in the art. Similar, the ground plane 20 can also have a rectangular, circular, or triangular shape as known by one skilled in the art. In one embodiment, the metallic sidewall 40 can also be realized by a metallic sheet or shoring vias.

An air substrate 50 with thickness of h is used between the radiating patch 10 and the ground plane 20 to enhance the impedance bandwidth. In the present embodiment, h=5.5 mm. In other embodiments, the air substrate 50 can be replaced by other substrates, such as dielectric substrates and so on.

For exciting the patch antenna, a feeding device 30 is used to feed the patch antenna and excite its fundamental TEM mode, whose magnetic fields generate surface electric currents on the metallic sidewall 30 and electric fields generate surface magnetic currents on the open-ended slot 60.

In the present embodiment, the feeding device 30 is a coaxial cable whose inner conductor 31 is soldered to the radiating patch 10 at a displacement of s from the metallic sidewall, whose outer conductor 32 is connected to the ground plane 20. In the present embodiment, the displacement s between the inner conductor of the coaxial cable and the metallic sidewall is 5 mm. The inner conductor may be a cylindrical, conical, rectangular or any other shape as known by one skilled in the art.

In one embodiment, the patch antenna can be fabricated from a single copper brick with a thickness of 1 mm. In such embodiment, the coaxial cable is bent to be parallel with the patch antenna. Of course, in the other embodiment, the coaxial cable can also be perpendicular to the patch antenna. However, it is more preferable that the coaxial cable is bent to be parallel with the patch antenna. This is because it has been found in the measurement that if the coaxial cable is located perpendicularly to the patch antenna, the unbalanced current that excited outside the coaxial cable will significantly affect the antenna performance due to the ground plane 20. However, the influence becomes insignificant if the coaxial cable is parallel with the patch antenna.

In another embodiment, the quasi-isotropic patch antenna can be fabricated from a printed circuit board. In another embodiment,

It should be noted that, although the above description has given particular values for the size or dimensions of the patch antenna, one skilled in the art can adjust these values based on actual design requirement, fabrication environments and so on. The above values listed are not intend to limit present application, but for illustration.

To explain the operating principle of the proposed isotropic antenna, the fields and currents distributions of the patch antenna are investigated in detail. The E-fields of the patch antenna can be expressed as:

$$\vec{E} = \vec{y} {E}_{o} sin ( \frac{π z}{2 a} ) \qquad ( 1 )$$

Where Eₒ is the coefficient. Then, by using the Maxwell equation of ∇× [symbol] =jωμ [symbol] , the H-fields of the patch antenna can be written as:

$$\vec{H} = - \vec{x} j \frac{{E}_{o}}{η} cos ( \frac{π z}{2 a} ) \qquad ( 2 )$$

Where ω is the radian frequency, μ is the permeability and η is the wave impedance of free space. The resonance frequency of the TEM mode is approximately given by:

$$f = \frac{c}{2 ( 2 a + h )} \qquad ( 3 )$$

where c is the velocity of wave propagation in vacuum c=3×10⁸ m/s. Assuming that the fields vanish outside the cavity and applying the boundary conditions of [symbol] × [symbol] = [symbol] , ( [symbol] is the normal unit vector of the boundary), the surface electric currents on the metallic walls can be obtained:

$${\overline{J}}_{e} = \{ \begin{matrix}- \vec{z} \frac{{jE}_{0}}{η} cos ( \frac{π z}{2 a} ) , & y = h \\ \vec{z} \frac{{jE}_{0}}{η} cos ( \frac{π z}{2 a} ) , & y = 0 \\ - \vec{y} \frac{{jE}_{0}}{η} cos ( \frac{π z}{2 a} ) = - \vec{y} \frac{{jE}_{0}}{η} , & z = 0 \\ 0 , & otherwise\end{matrix} \qquad ( 4 )$$

Similarly, the surface magnetic currents on the open-ended slot can be obtained by using [symbol] × [symbol] =− [symbol] ₘ:

$${\vec{J}}_{m} = \{ \begin{matrix}- \vec{x} {E}_{0} sin ( \frac{π z}{2 a} ) = - \vec{x} {E}_{0} , & z = a \\ 0 , & otherwise\end{matrix} \qquad ( 5 )$$

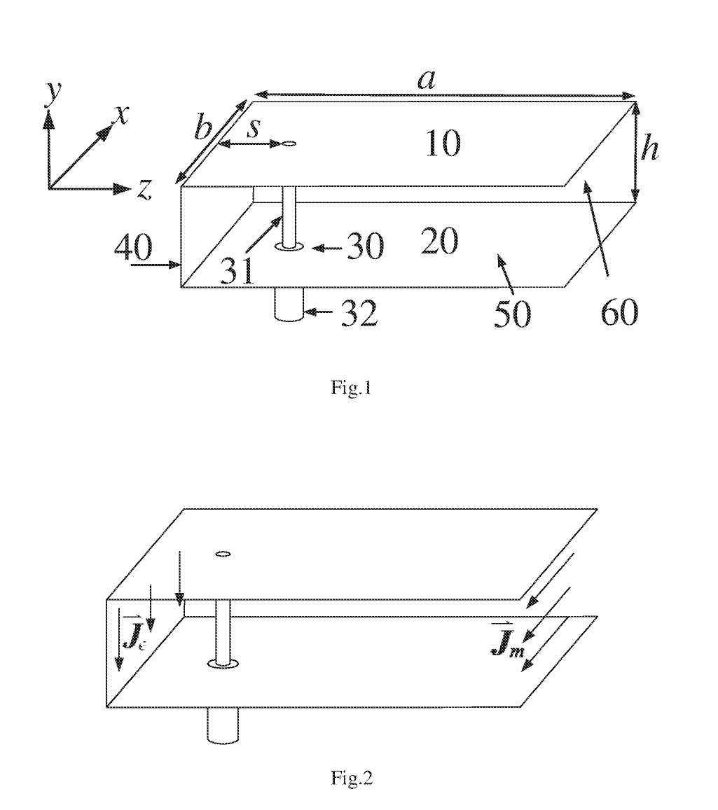

With reference to (4), the surface electric currents on the radiating patch (y=h) and the ground plane (y=0) have same amplitudes but opposite directions. Their radiation can therefore cancel out each other when the dimensions of the ground plane and the radiating patch are comparable and the height h is much smaller than a wavelength. Consequently, the radiation characteristics of the shorted patch antenna can be analyzed by only considering the y-directed surface electric currents (dipole) on the shorted side-wall (z=0) and the x-directed magnetic currents (dipole) on the open-ended slot (z=a), as shown in FIG. 2. Since the electric and magnetic currents (dipoles) are perpendicular and completely decoupled to each other, the far fields components E_{tθ} and E_{Tθ} of the complementary dipoles can be calculated by superimposing their individual counterparts.

$$\{ \begin{matrix}{E}_{T θ} = jFbh ( - η {J}_{e} cos θ sin φ + {J}_{m} sin φ ) \\ {E}_{T φ} = jFbh ( - η {J}_{e} cos φ + {J}_{m} cos θ cos φ )\end{matrix} \qquad ( 6 )$$

where F=βe^{jω[t-(r/c)]}/(4πr). It can be deduced from (4) and (5) that the currents inherently satisfy the relation of ηJₑ=−jJₘ=J, and therefore the fields can be simplified as:

$$\{ \begin{matrix}{E}_{T θ} = - FJbh sin φ ( 1 + j cos φ ) \\ {E}_{T φ} = - FJbh cos φ ( j + cos θ )\end{matrix} \qquad ( 7 )$$

Accordingly, the total far field E_{T} is given by

E_{T}=\sqrt{|E_{Tθ}|²}+|E_{Tθ}|²=FJbh\sqrt{1+cos²θ} (8)

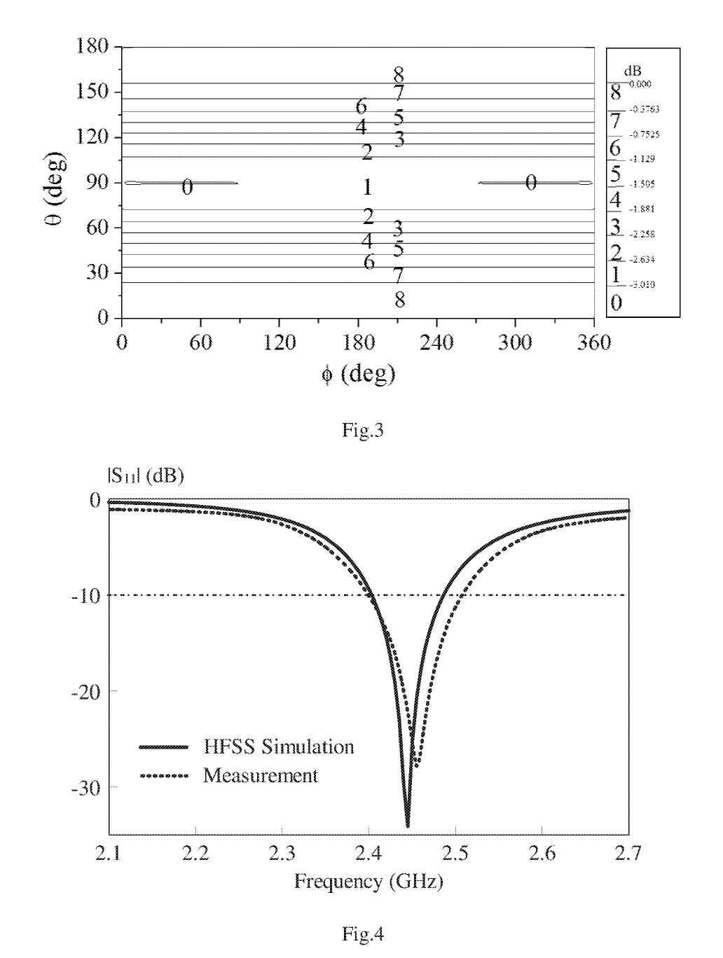

FIG. 3 shows calculated 3D radiation pattern of the patch antenna. With reference to the figure and (8), E_{T} is independent of 01) and it is only a function of θ. The theoretical maximum (θ=0, π) and minimum (θ=π/2) radiation power densities differ by 3 dB, indicating that the radiation is quasi-isotropic within full space.

For validating the design concept, a patch antenna covering the 2.4 GHz-WLAN band was designed, fabricated and measured. In the present application, the patch antenna is an isotropic shorted patch antenna which is fabricated from a single copper brick. The thickness of the copper plates is 1 mm. As discussed above, the other parameters are given by a=27 mm, b=27 mm, h=5.5 mm, s=5 mm.

In this embodiment, the coaxial cable is parallel with the patch antenna. To be more precise, a λ/4 choke (balun) is added to the outer conductor 32 of the coaxial cable to obtain a balanced current. In this context, the reflection coefficient and radiation performance (including radiation pattern, gain and efficiency) of the antenna are measured using an HP8510C network analyzer and a Satimo StarLab System, respectively.

FIG. 4 shows simulated and measured reflection coefficients of the patch antenna, and good agreement between them is obtained. The simulated and measured resonance frequencies (min. (|S₁₁|) are given by 2.44 GHz and 2.45 GHz respectively, both are a bit lower than that (2.52 GHz) of the theoretical result. This discrepancy is partially caused by the loading effect of the feeding probe, and partially due to the fringe field effect which has not been taken into account in (3). The measured 10-dB impedance bandwidth (|S₁₁|<−10 dB) is 4.48% (2.40-2.51 GHz), comparable to that (˜5%) of a traditional patch antenna.

FIG. 5A-5B shows calculated, simulated, and measured field patterns of the quasi-isotropic patch antenna in the elevation (xz) and azimuthal (xy) planes. In each plane, the agreement between simulated and measured results is satisfactory, but there is a small discrepancy in the calculated pattern. This is reasonable since ideal uniform current distributions on the side-walls are assumed in the above analysis. It can be seen that the elevation pattern is near omnidirectional, whereas the azimuthal pattern contains two figure-8 patterns. Apparently, the E₀ and E_{φ} figure-8 patterns are generated by the y-directed electric currents (dipole) and the x-directed magnetic currents (dipole), respectively. The field patterns in the yz plane are similar with that in the xz plane, consistent with the theory given by (7).

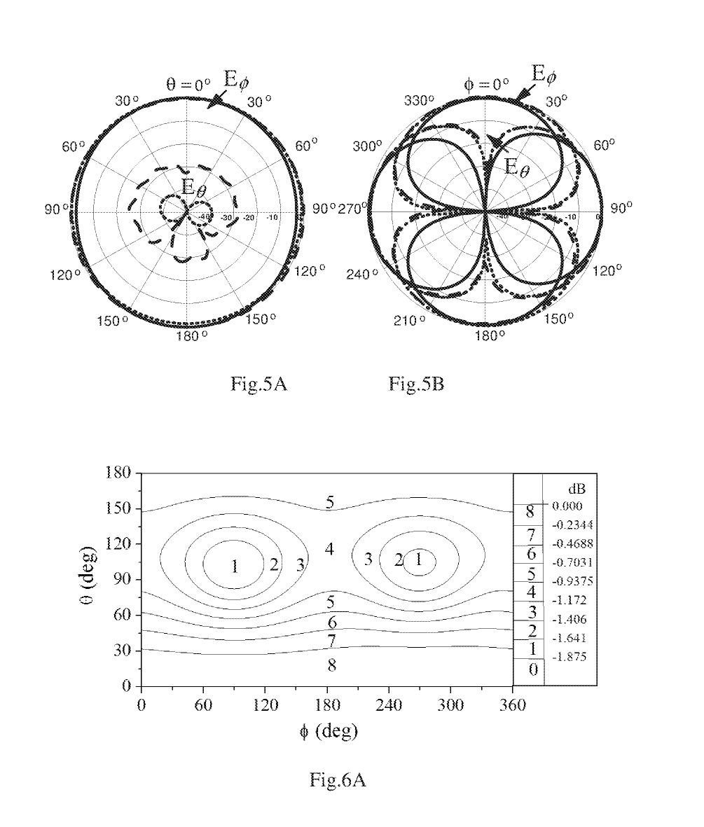

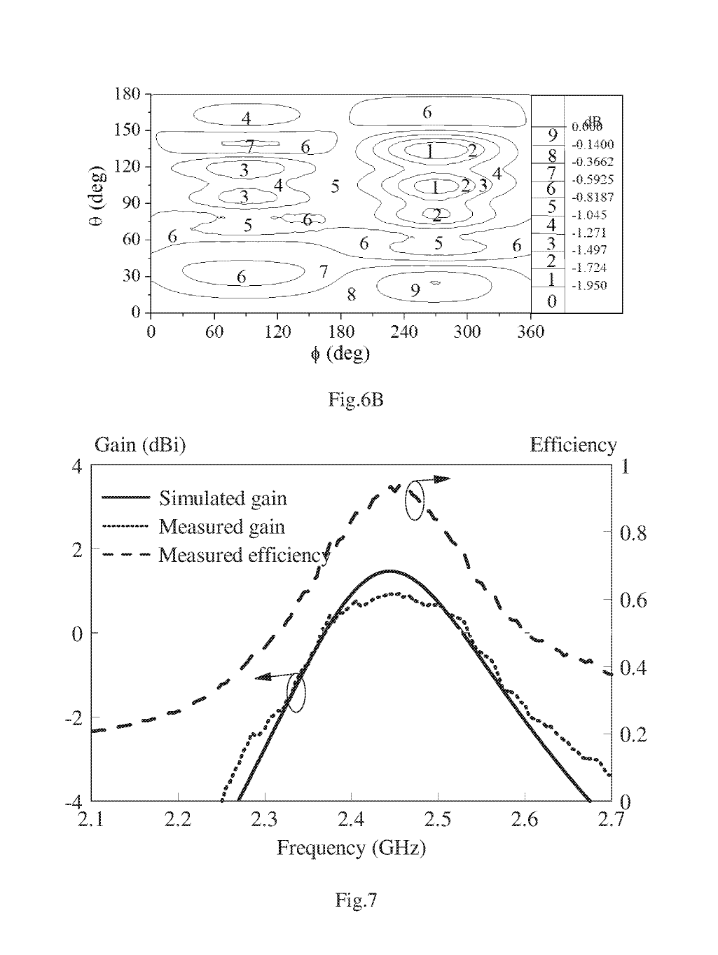

For more detail, FIG. 6A-6B show simulated and measured 3D radiation patterns of the shorted patch antenna at 2.44 GHz. Quite an isotropic pattern is observed both in the simulation and measurement, as expected. The differences between the maximum and minimum radiation power densities are given by 1.88 dB (simulation) and 1.95 dB (measurement), respectively. Compared with the theoretical pattern shown in FIG. 3, the simulated and measured patterns become more uniform due to the real current distribution. Radiation patterns at other frequencies have also been studied, and they are found to be very stable across the entire operating band.

FIG. 7 shows realized gains of the patch antenna at θ=0°, along with the efficiency. As can be observed from the figure, the measured gain varies between ˜0.64 dBi and ˜0.93 dBi within the WLAN-band, and the average efficiency is about 90%.

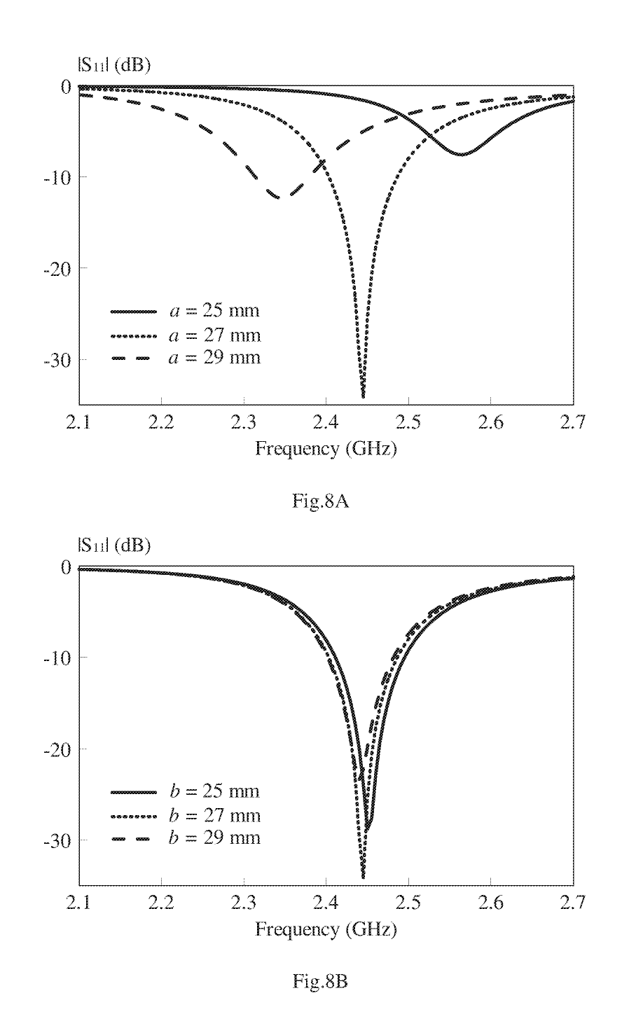

In this section, a parametric study of the proposed patch antenna is carried out to further characterize the design. Only one parameter is varied each time, with all the rest fixed at their optimal values as listed above. The effects of patch dimensions on the antenna performance are studied first. FIGS. 8A, 8B and 8C show the simulated reflection coefficients for different patch lengths, widths and heights, respectively. It can be observed that the resonance frequency shifts downward quickly from 2.56 GHz to 2.34 GHz as a increases from 25 mm to 29 mm, however it is insensitive with the variation of width b. This is because b corresponds to the dimension of non-radiating edge of the patch. The variation trend of reflection coefficient with height h is similar to that of a, verifying again that the resonance frequency approximately satisfies the relation of f=c/(4a+2h). It was found in HFSS study that the patch dimension also affects the distribution of radiation power density. For reference, Table I lists the difference between maximum and minimum field strengths over the entire spherical radiation surface. Again, the effect of b is much smaller than that of a and h, as expected. The field strength difference at resonance frequency changes from ˜1.4 dB to ˜2.3 dB when h increases from 3.5 mm to 7.5 mm, indicating that a patch antenna with lower profile is preferable to provide a more isotropic radiation.

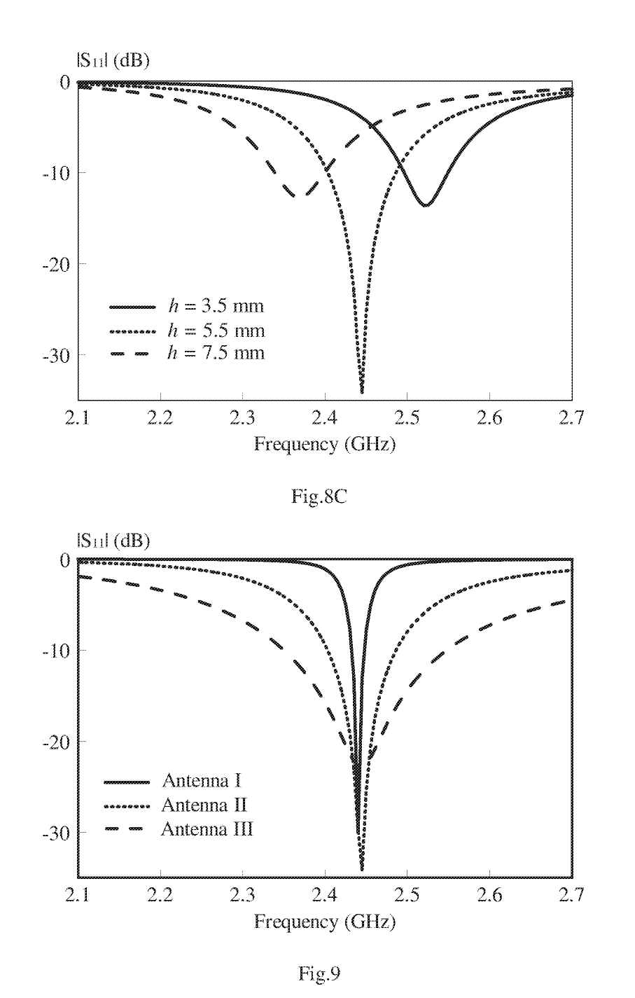

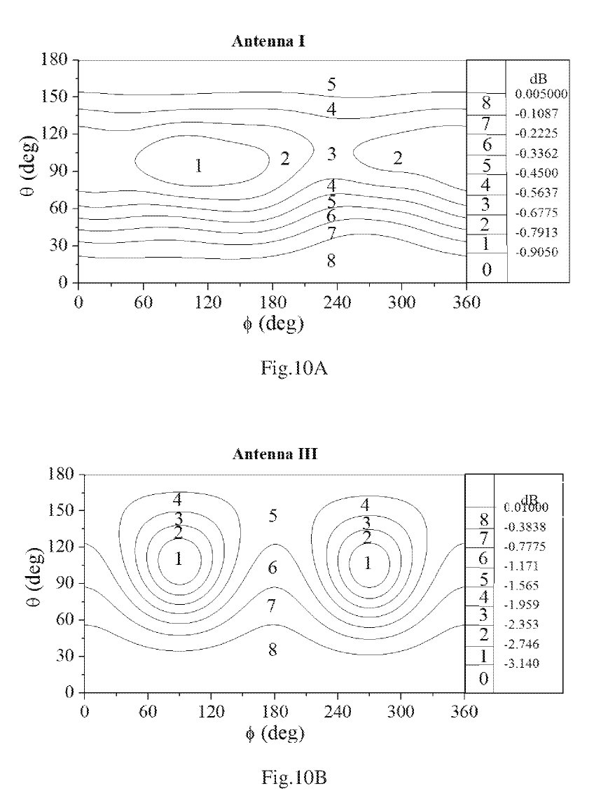

To investigate the limitation of radiation uniformity, three shorted patch antennas with different height h are designed to operate at ˜2.4 GHz. In each design, the dimensions of patch (a, b) and the location of feeding device (s) are tuned to optimize the antenna. FIG. 9 shows simulated reflection coefficients of different patch antennas operating at 2.4-GHz. FIG. 10A-10B shows 3D radiation patterns of patch antennas. Table II summarizes the antenna dimensions, bandwidths, and gain differences. With reference to FIG. 9, 10A-10B and Table II, the low profile antenna with h=1 mm shows a narrow bandwidth of 0.6% and a very uniform radiation having gain difference of 0.9 dB. The gain difference undesirably increases to ˜3.1 dB for the antenna with h=10 mm. However, a much wider bandwidth of ˜8.2% is obtained because of the thick substrate. The bandwidth can be further enhanced to ˜15% if a gain difference of ˜6 dB is acceptable. Therefore, there is a tradeoff between radiation uniformity and impedance bandwidth. The designer has the flexibility of selecting the isotropic patch antenna most suitable for the intended application.

Next, the position of feeding device is investigated and the result is shown in FIG. 11. Similar to the traditional patch antenna, the feeding position significantly affects the impedance match due to its loading effect. The influence of s on the radiation pattern is also studied. It is found that the gain difference varies slightly from 1.83 dB to 1.90 dB as s increases from 3 mm to 7 mm. The results reveal that s can be used to tune the match after the isotropic pattern is optimized by tuning the patch dimensions.

TABLE I
THE DIFFERENCE BETWEEN THE MAXIMUM AND MINIMUM
FIELD STRENGTHS OF THE SHORTED PATCH ANTENNA.

| a | Difference | b | Difference | h | Difference |
|---|---|---|---|---|---|
| (mm) | (dB) | (mm) | (dB) | (mm) | (dB) |
| 25 | 2.04 | 25 | 1.83 | 3.5 | 1.40 |
| 27 | 1.88 | 27 | 1.88 | 5.5 | 1.88 |
| 29 | 1.76 | 29 | 1.88 | 7.5 | 2.31 |

TABLE II
DIMENSIONS, BANDWIDTHS AND GAIN
DIFFERENCES OF THE THREE DIFFERENT
ANTENNAS OPERATING AT 2.4-GHz.

| | Patch | Feeding | | |
|---|---|---|---|---|
| | dimensions | position | Impedance | Gain |
| Antenna | a × b × h (mm) | s (mm) | bandwidth | difference (dB) |
| I | 29.4 × 29.4 × 1 | 3.4 | 0.61% | 0.91 |
| II | 27 × 27 × 5.5 | 5.0 | 3.48% | 1.88 |
| III | 29.4 × 29.4 × 10 | 14.4 | 8.16% | 3.13 |

TABLE III
MAXIMUM AND MINIMUM FIELD STRENGTHS
OF THE SHORTED PATCH ANTENNA WITH
DIFFERENT GROUND PLANES.

| Ground | Max. field | Min. field | |
|---|---|---|---|
| size (mm2) | strength (dB) | strength (dB) | Difference (dB) |
| 27 × 27 | 1.47 | −0.41 | 1.88 |
| 37 × 37 | 2.48 | −2.73 | 5.21 |
| 67 × 67 | 4.04 | −20.47 | 24.51 |

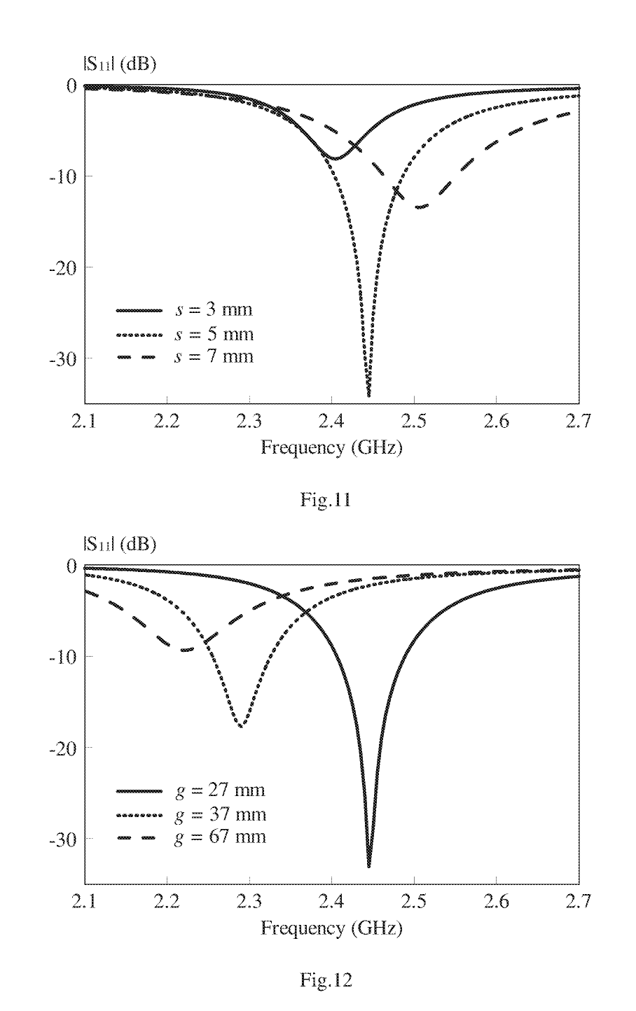

As discussed above, the ground plane plays an important role in obtaining the isotropic radiation pattern. Therefore, the effect of different ground plane side-lengths, e.g. g=27 mm, 37 mm and 67 mm is illustrated in FIG. 12. As can be seen from the figure, the resonance frequency is 2.44 GHz for the antenna with g=27 mm, and it shifts downwards to 2.23 GHz when g=67 mm. This is due to the fact that a good image of the patch is obtained when using a sufficiently large ground plane. The height is therefore increased to be 2h according to the image theory, and the resonance frequency is consequently given by f=c/(4a+4h). The matching level at corresponding resonance frequency also changes with the variation of g, and more importantly, significant changes have happened in the far filed radiation patterns. Table III compares the maximum gain, minimum gain, and the difference between them for the three antennas. An isotropic pattern is obtained when using a small ground plane (27 mm), with the gain difference given by 1.88 dB. The difference increases significantly as g increasing, and even reaches 24.5 dB when g=67 mm. A unidirectional pattern with maximum radiation found near y axis is resulted. This is to be expected, because the antenna turns into a normal patch antenna having large ground plane. The large ground plane weakens significantly the strength of back radiation, and meanwhile, the radiation caused by the currents on the patch and that on the ground plane cannot completely cancel out each other, resulting in a broadside radiation pattern.

Based on the parametric study, a simple guideline is given to facilitate the design of the proposed patch antenna. It is assumed that the design frequency and wavelength are f₀ and λ₀, respectively.

1) Firstly, setting the initial dimensions of the radiating patch as a=b=0.25λ₀, and h=0.04 λ₀ (a larger h of 0.1λ₀ can be chosen if wider bandwidth is required). Using a ground plane as large as the patch (g=0.25λ₀). Then connecting the radiating patch and the ground plane by a metallic side-wall.

2) Then, inserting a feeding device near the metallic side-wall to feed the patch antenna, with s=0.2a.

3) Tuning dimensions of the radiating patch to optimize the isotropic pattern, and adjusting feeding position of the feeding device for good match.

4) Repeating procedure (3) until satisfying performance is achieved.

In one embodiment, procedure (2) further comprises the following steps: soldering inner conductor of the feeding device to the radiating patch at a displacement from the metallic sidewall; connecting outer conductor of the feeding device to the ground plane; and bending the feeding device to be parallel with the patch antenna.

In one embodiment, the method of fabricating a patch antenna further comprises arranging an air substrate between the radiating patch and the ground plane to enhance impedance bandwidth of the patch antenna.

A probe-fed shorted patch antenna with isotropic radiation pattern is obtained by the present application. The patch antenna uses a small ground plane which has same dimensions with the radiating patch, therefore the radiation caused by the currents on the radiating patch is cancelled out by that comes from the opposite currents on the ground plane. Quasi-TEM mode is excited in the radiating patch cavity, generating surface magnetic currents on the open-ended slot and electric currents on the shorted side-wall. Taking advantage of the inherent properties of the orthogonal electric and magnetic fields (currents), the shorted patch antenna provides an isotropic radiation pattern without using complex feeding circuit. A 2.4-GHz prototype was designed and measured to verify the theory. Uniform radiation with gain difference of 1.95 dB is obtained over the 360° fullspace. It has been found that there is a tradeoff between radiation uniformity and impedance bandwidth. By tuning the height of the patch, an antenna with bandwidth of 8% (or 0.6%) and gain difference of 3.1 dB (or 0.9 dB) can be obtained.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A quasi-isotropic patch antenna consisting of a radiating patch, a ground plane, and a metallic sidewall which connects the former two to form an open-ended slot, wherein a feeding device is used to feed the quasi-isotropic patch antenna and excite its fundamental TEM mode, whose magnetic fields generate surface electric currents on the metallic sidewall and electric fields generate surface magnetic currents on the opposite open-ended slot.

2. The quasi-isotropic patch antenna according to claim 1, wherein the radiating patch is a quarter-wave radiating patch.

3. The quasi-isotropic patch antenna according to claim 2, wherein the radiating patch has a rectangular, circular, or triangular shape.

4. The quasi-isotropic patch antenna according to claim 1, wherein the radiating patch and the ground plane have the same dimensions.

5. The quasi-isotropic patch antenna according to claim 1, wherein the feeding device is a coaxial cable comprising an inner conductor soldered to the radiating patch at a displacement from the metallic sidewall and an outer conductor connected to the ground plane.

6. The quasi-isotropic patch antenna according to claim 5, wherein the inner conductor has a cylindrical, a conical, or a rectangular shape.

7. The quasi-isotropic patch antenna according to claim 5, wherein the coaxial cable is bent to be parallel with the quasi-isotropic patch antenna.

8. The quasi-isotropic patch antenna according to claim 1, wherein the quasi-isotropic patch antenna is fabricated from a thin copper brick.

9. The quasi-isotropic patch antenna according to claim 1, wherein the quasi-isotropic patch antenna is fabricated from a printed circuit board.

10. The quasi-isotropic patch antenna according to claim 1, wherein a dielectric substrate is used between the radiating patch and the ground plane.

11. The quasi-isotropic patch antenna according to claim 10, wherein the substrate is a dielectric substrate or an air substrate.

12. The quasi-isotropic patch antenna according to claim 1, wherein the metallic sidewall is realized by a metallic sheet or shoring vias.

13. A quasi-isotropic patch antenna comprising a quarter-wave rectangular radiating patch, a ground plane, and a metallic sidewall which connects the former two to form an open-ended slot, and a :feeding device used to feed the quasi-isotropic patch antenna and excite its fundamental TEM mode, whose magnetic fields generate surface electric currents on the metallic sidewall and electric fields generate surface magnetic currents on the opposite open-ended slot.

14. The quasi-isotropic patch antenna according to claim 13, wherein the quarter-wave rectangular radiating patch and the ground plane have same dimensions.

15. The quasi-isotropic patch antenna according to claim 14, wherein the feeding device is a coaxial cable comprising an inner conductor soldered to the quarter-wave rectangular radiating patch at a displacement from the metallic sidewall and an outer conductor connected to the ground plane, wherein the coaxial cable is bent to be parallel with the quasi-isotropic patch antenna.

16. The quasi-isotropic patch antenna according to claim 15, wherein a dielectric substrate is used between the quarter-wave rectangular radiating patch and the ground plane.

17. The quasi-isotropic patch antenna according to claim 16, wherein the metallic sidewall is realized by a metallic sheet or shoring vias.

18. A method of fabricating a quasi-isotropic patch antenna comprising the following steps:
S1, setting a radiating patch and a ground plane as large as the radiating patch;
S2, connecting the radiating patch and the ground plane by a metallic side-wall;
S3, inserting a feeding device near the metallic side-wall to feed the quasi-isotropic patch antenna,
S4, tuning dimensions of the radiating patch to optimize the isotropic pattern, and adjusting feeding position of the feeding device for good match,
S5, repeating step S4 until satisfying performance is achieved.

19. The method of fabricating a quasi-isotropic patch antenna according to claim 18, wherein step S3 further comprising the following steps:
S31, soldering inner conductor of the feeding device to the radiating patch at a displacement from the metallic sidewall;
S32, connecting outer conductor of the feeding device to the ground plane; and
S33, bending the feeding device to be parallel with the quasi-isotropic patch antenna.

20. The method of fabricating a quasi-isotropic patch antenna according to claim 18, wherein further comprising the following step:
S6, arranging an air substrate between the radiating patch and the ground plane to enhance impedance bandwidth of the quasi-isotropic patch antenna.
